(19) United States
(12) Patent Application Publication
(10) Pub. No.: US 2016/0329559 A1
(43) Pub. Date: Nov. 10, 2016

(54) LITHIUM SULFIDE MATERIALS AND COMPOSITES CONTAINING ONE OR MORE CONDUCTIVE COATINGS MADE THEREFROM

(71) Applicant: THE REGENTS OF THE UNIVERSITY OF CALIFORNIA, Oakland, CA (US)

(72) Inventors: Elton J. Cairns, Walnut Creek, CA (US); Zhan Lin, Albany, CA (US); Wujun Fu, Joplin, MO (US)

(21) Appl. No.: 15/109,102

(22) PCT Filed: Dec. 30, 2014
(86) PCT No.: PCT/US14/72827

§ 371 Date: Jun. 29, 2016

Related U.S. Application Data
(60) Provisional application No. 61/921,807, filed on Dec. 30, 2013.

(51) Int. Cl. H01M 4/36; H01M 4/58; H01M 4/04; H01M 4/136; H01M 4/133; H01M 4/583; H01M 10/0525

(52) U.S. Cl. CPC H01M 4/366; H01M 4/583; H01M 4/5815; H01M 10/0525; H01M 4/136; H01M 4/133; H01M 4/0428; H01M 4/0471; H01M 2220/20; H01M 2220/30

(57) ABSTRACT

The disclosure provides for nanosized Li₂S materials, the carbon coating of the Li₂S materials, and composites comprising the nanosized Li₂S materials and one or more conductive coatings. The disclosure further provides that these nanosized Li₂S containing materials or composite made thereof can be used in a variety of applications, including for use in Li/S batteries.

### CROSS REFERENCE TO RELATED APPLICATIONS

This application claims priority under 35 U.S.C. §119 from Provisional Application Ser. No. 61/921,807, filed Dec. 30, 2013, the disclosure of which is incorporated herein by reference.

### TECHNICAL FIELD

The disclosure relates to carbon coated lithium sulfide materials, and the use of these materials in lithium/sulfur batteries and the batteries derived therefrom.

### BACKGROUND

In order to meet the challenge of man-made climate change and the finite nature of fossil fuels, it is important that new, low-cost and environmentally friendly energy conversion and storage systems be developed. The lithium ion battery is the most prevalent portable energy storage device in current use. However, the most widely used cathode material, LiCoO₂, has many limitations due to safety, cost, and toxicity issues. Although new cathode materials, such as LiFePO₄ and layer-structured LiMnO₂, are being developed to replace LiCoO₂ in lithium cells, these transition metal oxide cathode materials show relatively low specific capacities.

### SUMMARY

The disclosure provides for nanometer sized Li₂S (NanoLi₂S) materials that can further comprise one or more conductive coatings (e.g., carbon nano-shells). The NanoLi₂S materials disclosed herein can be used for a variety of applications, including for use in high performance Li/S batteries. In experiments presented herein, Li/S cells comprising NanoLi₂S composite materials have improved cycling performance and higher sulfur utilization over conventional Li/S based cells. Coating the NanoLi₂S materials with one or more conductive coatings prevents the NanoLi₂S materials from coming into direct contact with a liquid electrolyte, thereby greatly improving the cycling performance of Li/S cells. Further, when carbon-coated NanoLi₂S composite materials are mixed with graphene oxide (GO) or a conductive polymer, the cyclability and rate capability of the NanoLi₂S cells is further enhanced. The functional groups of GO chemically absorb polysulfides, preventing them from dissolving in the liquid electrolyte. The resulting GO-carbon coated NanoLi₂S cells are far superior to conventional Li/S cells. Accordingly, cathodes comprising NanoLi₂S materials of the disclosure can be used in the most demanding and energy intensive battery powered applications.

The disclosure provides a method of synthesizing a nano-lithium-sulfide (NanoLi₂S) material comprising reacting elemental sulfur with a lithium-based reducing agent in an aprotic solvent. In one embodiment, the aprotic solvent is tetrahydrofuran. In another or further embodiment, the lithium-based reducing agent is selected from lithium triethylborohydride, n-butyllithium, and lithium aluminum hydride. In yet another or further embodiment, the NanoLi₂S material primary particle size is between 20 to 30 nm in size. In yet another or further embodiment, the solvent is removed in vacuo and the NanoLi₂S material is heated at an elevated temperature. In a further embodiment, the NanoLi₂S material is heat treated at a temperature of at least 500° C. In yet a further embodiment, the NanoLi₂S material is uniformly sized particles having a diameter between 200 to 700 nm. In yet another or further embodiment, the NanoLi₂S material is substantially spherical or substantially ovoid in shape.

The disclosure also provides a method of coating the NanoLi₂S material of any of the foregoing embodiments with a conductive carbon based coating comprising: applying a coating of a carbon based polymer to the NanoLi₂S material; pyrolyzing the polymer coated nanoLi₂S material under an inert atmosphere so as to form a pyrolytic carbon based coating on the NanoLi₂S materials. In another embodiment, the carbon based polymer is selected from polystyrene (PS), polyacrylonitrile (PAN), polymetylmetacrylate (PMMA), or combinations thereof. In yet another or further embodiment, the polymer coated nanoLi₂S material is pyrolyzed by heating the material at a temperature between 400° C. to 700° C. for up to 48 hours. In yet another or further embodiment, the method further comprises heating the carbon coated NanoLi₂S materials at a temperature greater than 700° C. to 1350° C. for up to 48 hours so as to form a pyrolytic graphene based coating on the NanoLi₂S materials. In a further embodiment, the steps are repeated multiple times where the carbon coated NanoLi₂S materials are milled after each pyrolyzation step to break up any large agglomerations.

The disclosure also provides a method of coating the NanoLi₂S material of the disclosure with a conductive carbon based coating comprising: placing the NanoLi₂S material under an atmosphere which comprises inert gas and carbon containing precursor compound, wherein the inert gas and carbon containing precursor compound are independently introduced at defined Standard Cubic Centimeters per Minute (SCCM) flow rates; and depositing a carbon coating on the NanoLi₂S material by pyrolyzing the carbon containing precursor compound at a temperature between 400° C. to 700° C. for up to 48 hours. In a further embodiment, the steps are repeated multiple times where the carbon coated NanoLi₂S materials are milled after each deposition step to break up any large agglomerations. In yet a further embodiment, the method comprises three deposition steps of 30 minutes, 60 minutes, and 120 minutes at 450° C., and where the carbon coated NanoLi₂S materials are milled after each depositing step. In yet another or further embodiment, the carbon containing precursor compound is selected from methane, ethylene, acetylene, benzene, ethane, carbon monoxide, or combinations thereof. In yet another or further embodiment, the SCCM flow rate of the inert gas and carbon containing precursor compound is adjusted to desired flow rates using a mass flow controller. In yet another or further embodiment, the SCCM flow rate ratio of inert gas to carbon containing precursor compound is from 10:1 to 1:10.

The disclosure also provides a method of further coating the carbon coated NanoLi₂S material of various embodiments of the foregoing with a coating to prohibit the migration of polysulfide species, comprising: applying a coating of graphene oxide (GO) or a conductive polymer to the carbon coated NanoLi₂S material. In a further embodiment, a coating of GO is applied to the carbon coated NanoLi₂S material by: combining suspension A comprising GO in NMP with suspension B comprising carbon coated NanoLi₂S, Super P carbon black, and polyvinylpyrrolidone (PVP) binder in NMP. In yet a further embodiment, the suspensions are agitated using sonification. In yet another or further embodiment, the combined suspensions form a composition where the carbon coated NanoLi₂S/GO composite makes up 50% to 85% by weight of the composition, not including the liquid solvent. In a further embodiment, the conductive polymer is selected from polypyrrole (PPy), poly(3,4-ethylenedioxythiophene)-poly(styrene sulfonate) (PEDOT:PSS), polyaniline (PANI), polypyrrole (PPy), polytiophene (PTh), polyethylene glycol, polyaniline polysulfide (SPAn), amylopectin, or combinations thereof. In yet another or further embodiment, the carbon coated NanoLi₂S material composite comprising a conductive polymer coating is treated with ethylene glycol, dimethyl sulfoxide (DMSO), salts, zwitterions, cosolvents, acids (e.g., sulfuric acid), geminal diols, amphiphilic fluoro-compounds, or combinations thereof.

The disclosure also provides a method of further coating the composite material of any of the foregoing embodiments with one or more coatings of conductive polymer, comprising: applying one or more coatings of a conductive polymer to the carbon coated NanoLi₂S GO composite material or the carbon coated NanoLi₂S conductive polymer composite material. In a further embodiment, the conductive polymer is selected from polypyrrole (PPy), poly(3,4-ethylenedioxythiophene)-poly(styrene sulfonate) (PEDOT:PSS), polyaniline (PANI), polypyrrole (PPy), polytiophene (PTh), polyethylene glycol, polyaniline polysulfide (SPAn), amylopectin, or combinations thereof. In yet another or further embodiment, the composite material is treated with ethylene glycol, dimethyl sulfoxide (DMSO), salts, zwitterions, cosolvents, acids (e.g., sulfuric acid), geminal diols, amphiphilic fluoro-compounds, or combinations thereof.

The disclosure also provides a battery comprising a NanoLi₂S based material as described above and below. In one embodiment, the battery is a lithium sulfide battery. In yet another or further embodiment, configured to be used in electronic devices or electric vehicles.

### DESCRIPTION OF DRAWINGS

FIG. 1 presents a cross-sectional view of an embodiment of the disclosure of a NanoLi₂S based composite that further comprises multiple conductive coatings.

FIG. 2 provides a scanning electron microscope (SEM) image of the NanoLi₂S material.

FIG. 3A-C provides for the synthesis and characterization of NanoLi₂S materials and carbon-coated NanoLi₂S composite materials. (A) A schematic for generating NanoLi₂S composite materials comprising a carbon coating. (B) A scanning electron microscope (SEM) image of NanoLi₂S. (C) A transmission electron microscope (TEM) image of carbon-coated NanoLi₂S composite materials.

FIG. 4 presents x-ray diffraction (XRD) patterns of NanoLi₂S, and NanoLi₂S after heat-treatment at 500° C. and with a carbon coating.

FIG. 5 provides Raman spectra of NanoLi₂S, and NanoLi₂S after heat-treatment at 500° C. and with a carbon coating.

FIG. 6 presents a schematic of a Li/S battery cell comprising a cathode of the carbon coated NanoLi₂S composite material.

FIG. 7A-E provides for electrochemical evaluation of cathode materials for Li/S cells (1C=1,166 mA g⁻¹ NanoLi₂S) comprising carbon-coated NanoLi₂S composite materials that have been mixed with 20 wt % GO (carbon-coated NanoLi₂S/GO composite materials). (A) Cyclic voltammogram at the potential range of 1.5-4.0 V vs. Li/Li⁺ by using scan rate of 0.025 mV s⁻¹. (B) Representative voltage profiles at the 1^{st} and 3^{rd} cycle. (C) The cycling comparison of NanoLi₂S materials, carbon-coated NanoLi₂S composite materials, and carbon-coated NanoLi₂S/GO composite materials, respectively, at the C/2 rate. (D) The coulombic efficiency. (E) The rate capability.

FIG. 8A-F demonstrates that when the NanoLi₂S materials are coated with carbon and GO, the dissolution of polysufides is inhibited thereby improving cycling performance. (A) A polysulfide dissolution test comparing NanoLi₂S materials versus carbon-coated NanoLi₂S composite materials. The color changes of these two samples containing the same amount of NanoLi₂S materials were recorded by camera at the indicated times. NEXAFS spectra of C K-edge of cathodes comprising the carbon-coated NanoLi₂S/GO composites at different (B) discharge and (C) charge cycles. The curves show the spectra of the TFY signal from the cathode materials during cycling. (D) NEXAFS spectroscopy of S Kedge of the NanoLi₂S/GO composites from the TFY signal. (E-F) TFY S K edge NEXAFS spectra of the cathode materials with five different charge/discharge cycles and stopped at the (E) charged and (F) discharged states.

FIG. 9A-B show electrochemical test results (long term cycle test). (A) Representative potential profiles various cycles. (B) Representative cycle vs. discharge plot.

### DETAILED DESCRIPTION

As used herein and in the appended claims, the singular forms “a,” “and,” and “the” include plural referents unless the context clearly dictates otherwise. Thus, for example, reference to “an anode” includes a plurality of such anodes and reference to “lithium ion cell” includes reference to one or more lithium ion cells and equivalents thereof known to those skilled in the art, and so forth.

Also, the use of “or” means “and/or” unless stated otherwise. Similarly, “comprise,” “comprises,” “comprising” “include,” “includes,” and “including” are interchangeable and not intended to be limiting.

It is to be further understood that where descriptions of various embodiments use the term “comprising,” those skilled in the art would understand that in some specific instances, an embodiment can be alternatively described using language “consisting essentially of” or “consisting of.”

Unless defined otherwise, all technical and scientific terms used herein have the same meaning as commonly understood to one of ordinary skill in the art. Although there are many methods and reagents similar or equivalent to those described herein, the exemplary methods and materials are presented herein.

The development of a rechargeable battery with high specific energy is of considerable technological importance due to increasing energy storage needs for renewable energy generation and low-emission electrical vehicles. Lithium/sulfur (Li/S) batteries have a theoretical specific energy of 2,600 Wh kg⁻¹, which is 5 times greater than that of lithium-ion (Li-ion) batteries. Moreover, sulfur is inexpensive, abundant and nontoxic. Although considerable effort has been dedicated to improving the performance of sulfur cathodes, the polysulfide shuttle, which results from the dissolution of sulfur species in organic liquid electrolytes, presents a tough challenge for improving the performance and efficiency of Li/S batteries. Moreover, the use of elemental lithium as the anode in Li/S batteries also poses problems. Serious safety concerns are associated with cycling highly reactive lithium metal in flammable organic electrolytes; lithium dendrites that form during battery cycling penetrate the separator and cause fire hazards. However, cells composed of lithium metal as the anode and elemental sulfur as the cathode, i.e., lithium/sulfur (Li/S), are considered as a leading next-generation energy storage system for electric vehicles and large-scale grids.

Based on the following conversion reaction:

16Li+S₈ [symbol] 8Li₂S (1)

Li/S cells can supply a theoretical specific energy of 2,600 Wh kg⁻¹, which is five times greater than that of lithium-ion (Li-ion) cells.

In conventional Li/S cells, the elemental sulfur and its solid discharge products are neither electronically nor ionically conductive. To enable the electrochemical reaction of the sulfur cathode, carbon materials or conducting polymers have been investigated to improve their electronic conductivity, while liquid electrolytes have been used for the enhancement of the ionic conductivity. A liquid electrolyte, which consists of a lithium salt and a polar organic solvent, has been used as both the charge transfer medium and ionic conductor within the sulfur-containing cathode. The solubility of polysulfides in the electrolyte leads to a significant challenge in conventional Li/S cells, i.e., the polysulfide shuttle. The polysulfide shuttle causes the migration of sulfur species from the cathode to the anode, resulting in the loss of active material, short cycle life of the sulfur-based electrode, and low coulombic and energy efficiencies. Moreover, cycling the metallic lithium anode in a conventional organic liquid electrolyte remains a problem. The metallic lithium is very reactive in the liquid electrolyte medium and forms dendrites during cycling, which penetrate the separator and cause shorting, resulting in cell failure, and presenting a fire hazard.

Lithium sulfide (Li₂S), the prelithiated sulfur cathode in Li/S cells, has been studied due to its favorable high theoretical specific capacity of 1,166 mAh g⁻¹. Moreover, the Li₂S cathode supplies lithium thereby avoiding the direct use of a metallic lithium anode. Due to the relatively high melting point of Li₂S (1372° C. vs. 115° C. for sulfur), Li₂S can be heat treated at high temperatures in order to prepare a protective coating on the prelithiated sulfur cathode. The possible combination of the Li₂S cathode with a Si or Sn anode can dramatically enhance the energy density of rechargeable lithium cells over those using a carbon negative electrode. However, bulk Li₂S has electronic conductivity and ionic conductivity values as low as 10⁻¹⁴ and 10⁻¹³ S cm⁻¹, respectively; and it has been considered to be an electrochemically inactive material.

The disclosure provides for a nanostructured Li₂S (NanoLi₂S) material that can be synthesized using green chemistry by reacting elemental S with lithium triethylborohydride (LiEt₃BH) in tetrahydrofuran (THF). To promote the electrochemical activity of NanoLi₂S particles, the particles are coated with conductive carbon by either a chemical vapor deposition (CVD) process or carbonization of a carbon-based polymer material. NanoLi₂S particles which comprise a carbon coating have enhanced electronic conductivity. Further the carbon coating prevents the dissolution of sulfur species, resulting in improved cycling performance. The cyclability of carbon-coated NanoLi₂S can be further improved by mixing it with a material that chemically constrains polysulfides within the cathode, such as graphene oxide and/or conductive polymers.

“Carbon material” refers to a material or substance comprised substantially of carbon. Carbon materials include ultrapure as well as amorphous and crystalline carbon materials. Examples of carbon materials include, but are not limited to, activated carbon, pyrolyzed dried polymer gels, pyrolyzed polymer cryogels, pyrolyzed polymer xerogels, pyrolyzed polymer aerogels, activated dried polymer gels, activated polymer cryogels, activated polymer xerogels, activated polymer aerogels and the like. “Carbon material” is also referred to herein as the “carbon shell” with respect to the disclosed composites.

The disclosure provides methods for forming carbon nanoshells on NanoLi₂S (carbon coated NanoLi₂S) for high performance Li/S batteries. Carbon coated NanoLi₂S materials have a favorable high theoretical capacity of 1,155 mAh g⁻¹, which is far above that of LiFePO₄ and LiCoO₂ (150-170 mAh g⁻¹). The pre-lithiated cathode also avoids the direct use of metallic lithium as the anode. The carbon coated NanoLi₂S materials of the disclosure can accommodate the 76% volume change that accompanies lithium transfer. This accommodation of the swelling and shrinkage contributes to improving the cycle life and maintains better active material/current collector contact leading to higher charge/discharge rates and higher specific capacity.

The disclosure provides methods for the preparation of NanoLi₂S composites which further comprise one or more coatings to enhance electronic conductivity of the NanoLi₂S materials and to chemically constrain polysulfides. The disclosure further provides batteries, compositions and devices comprising the NanoLi₂S materials disclosed herein.

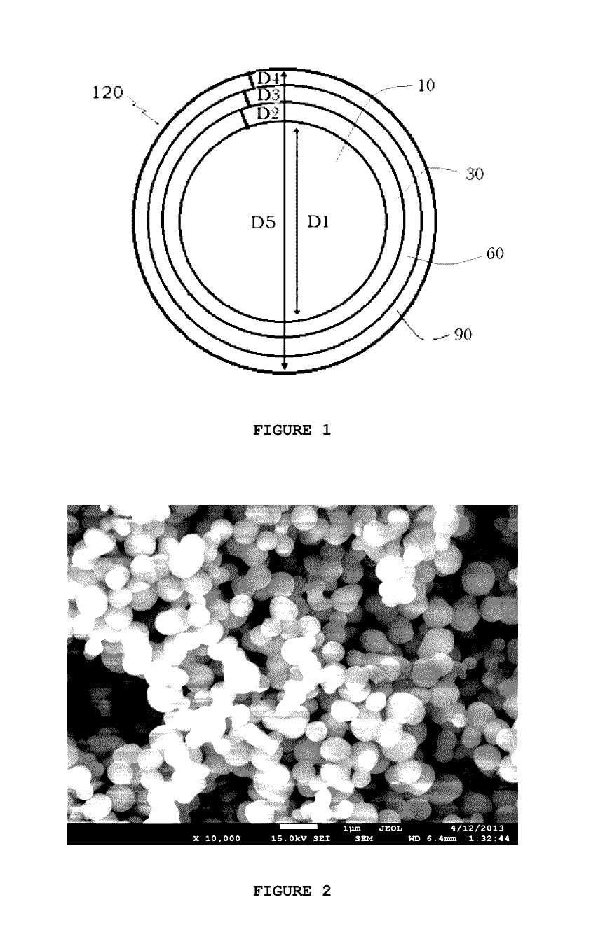

FIG. 1 depicts a particular embodiment of a composite 120 which comprises a NanoLi₂S core material. A “core material” is a NanoLi₂S based material which has a different composition than a coating material. The term “composite” as used herein denotes that the core material further comprises one or more coating materials. In some embodiments, the composite 120 comprises a NanoLi₂S core material 10, a first coating 30 that is in direct contact and encapsulates the core material 10, an optional second coating 60 that is in direct contact with and encapsulates the first coating 30, and an optional third coating 90 that is direct contact with and encapsulates second coating 60. In alternate embodiments, the first coating 30 covers only a portion of NanoLi₂S core material 10, i.e., first coating 30 does not fully encapsulate the NanoLi₂S core material 10. In further embodiments, second coating 60 covers only a portion of first coating 30, i.e., second coating 60 does not fully encapsulate first coating 30. In yet further embodiments, third coating 90 covers only a portion of second coating 60, i.e., third coating 90 does not fully encapsulate first coating 60. In a further embodiment, the NanoLi₂S core material 10 has a diameter of D1, wherein D1 is between 10 nm to 3 μm, 100 nm to 800 nm, 200 nm to 700 nm, 300 nm to 600 nm, 400 nm to 550 nm, or about 500 nm to 1 μm, or 1 μm to 2 μm, or greater than 2 μm (it should be apparent that the disclosure contemplates any value between 10 nm and 3 μm). In another embodiment, a NanoLi₂S composite material disclosed herein that comprises a NanoLi₂S core material 10 and a first layer 30 has a diameter of D1+D2, wherein D2 is between 1 nm to 200 nm, 2 nm to 100 nm, 5 nm to 90 nm, 10 nm to 50 nm, or 20 nm to 40 nm in length. In yet another embodiment, a NanoLi₂S composite material disclosed herein that comprises a NanoLi₂S core material 10, a first layer 30 and a second layer 60 has a diameter of D1+D2+D3, wherein D3 is between 1 nm to 50 nm, 2 nm to 30 nm, 3 nm to 20 nm, or 5 nm to 10 nm in length. In a further embodiment, a NanoLi₂S composite material disclosed herein that comprises a NanoLi₂S core material 10, a first layer 30, a second layer 60, and a third layer 90, has a diameter of D1+D2+D3+D4 or D5, wherein D4 is between 1 nm to 50 nm, 2 nm to 30 nm, 3 nm to 20 nm, or 5 nm to 10 nm in length. In one embodiment, D5 is 1 μm to 3 μm.

In some embodiments, a cathode comprises a NanoLi₂S based composite 120. Cathodes comprising NanoLi₂S based composite 120 are suitably employed in a battery, such as a lithium/sulfide (Li/S) battery. In another embodiment, the cathode comprises a carbon-coated NanoLi₂S, wherein the NanoLi₂S has a core Li₂S and one or more layers (e.g., D1, or D1+D2) of carbon or carbon and a conductive polymer.

In a certain embodiment, NanoLi₂S core material 10 is prepared by using standard techniques known in the art. For example, the NanoLi₂S core material 10 can be prepared by a solution-based reaction of elemental sulfur with a strong lithium based reducing agent such as, lithium superhydride (e.g., Li(CH₂CH₃)₃)BH), n-butyl-lithium, or lithium aluminum hydride, in any number of different weak acids (e.g., formic acid, acetic acid, and nitrous acid) and collecting the precipitate. More particularly, a method of forming NanoLi₂S materials can comprise mixing elemental sulfur with 1.0 M Li(CH₂CH₃)₃BH in THF, allowing the particles to precipitate, collecting the particles and washing the particles as necessary. In some embodiments, the NanoLi₂S particles are further dried by heating in vacuo. In a particular embodiment, the NanoLi₂S material is substantially spherical and/or substantially ovoid in shape (e.g., see FIG. 2). In an alternate embodiment, the NanoLi₂S material is a worm-like carbon structure, a carbon nanofiber, a carbon nano and/or micro-coil, or a combination comprising at least one of the foregoing.

In a certain embodiments, NanoLi₂S based composite 120 comprises a first coating 30. The first coating 30 increases the electronic conductivity of the composite comprising the nanoshell and core 10 in comparison to NanoLi₂S core material 10 without a first coating 30. The first coating 30 may be applied so that the coating uniformly coats the NanoLi₂S materials or alternatively the coating is applied so that the coating does not uniformly coat the NanoLi₂S materials (i.e., portions in which the coating is thicker and portions in which the coating is thinner including porous coatings). Alternatively, a first coating can be patterned on the NanoLi₂S materials, such as by using lithography based methods. For example, a first coating can be patterned on the NanoLi₂S materials using simple digital lithography (e.g., see Wang et al., Nat. Matter 3:171-176 (2004), which methods are incorporated herein) or soft lithography (e.g., see Granlund et al., Adv. Mater 12:269-272 (2000), which methods are incorporated herein). In one embodiment, first coating 30 is a porous electronically conductive coating. In a further embodiment, the first coating 30 is selected from carbon black, acetylene black carbon, pyrolytic carbon, pyrolytic graphene, or polyaniline polysulfide (SPan).

“Carbonizing”, “pyrolyzing”, “carbonization” and “pyrolysis” each refer to the process of heating a carbon-containing substance at a pyrolysis dwell temperature in an inert atmosphere (e.g., argon, nitrogen or combinations thereof) or in a vacuum such that the targeted material collected at the end of the process is primarily carbon.

The term “pyrolytic carbon” as used herein refers to an amorphous man made material of non-crystalline carbon in contrast to graphite, carbon black etc. which is produced by pyrolyzing a carbon precursor compound at a suitable temperature for a suitable time period.

The term “pyrolytic graphene” as used herein refers to graphene made by sintering pyrolytic carbon at a suitable temperature for a suitable time period to convert amorphous pyrolytic carbon to graphene.

The term “carbon based precursor compound” as used herein refers to a saturated or unsaturated C₁ to C₂₀ compound that may be optionally substituted.

In a particular embodiment the first coating 30 comprises carbon. A first coating 30 comprising carbon can be applied to the nanoLi₂S particles by using various techniques. For example, in one embodiment, a carbon-based coating can be applied to the NanoLi₂S materials by using a chemical vapor deposition process. In an alternate embodiment, a carbon-based coating can be applied to the NanoLi₂S materials by using a carbonization process. For example, NanoLi₂S materials can be carbon coated by preparing a mixture comprising a conductive carbon-based polymer, applying the mixture to the NanoLi₂S materials, and then carbonizing the carbon-based polymer by pyrolysis. The pyrolysis of the carbon based precursor compound is typically carried out in a non-oxygen environment and typically under a stream of inert gas such as, for example, Argon.

Accordingly, in a certain embodiment, a carbonization process is used to coat carbon on the NanoLi₂S materials by pyrolyzing a carbon based precursor compound. During the pyrolysis step, chemical and physical rearrangements occur, often with the emission of residual solvent and byproduct species, which can then be removed. As used in the disclosure, the term “carbon coating by carbonization” means that the carbon coating is generated from pyrolysis of a suitable carbon based precursor compound to amorphous pyrolytic carbon or pyrolytic graphene. A suitable precursor carbon compound (e.g., carbon based polymer) can be applied to the NanoLi₂S materials by any number of methods known in the art. For example, the NanoLi₂S materials can be immersed or soaked in a mixture, solution, or suspension comprising the carbon based precursor compound. Alternatively, a mixture, solution, or suspension comprising the carbon based precursor compound can be applied to the NanoLi₂S particles by spraying, dispensing, spin coating, depositing, printing, etc. The carbon based precursor compound can then be carbonized by heating the precursor compound at a suitable temperature, in an appropriate atmosphere, and for a suitable time period so that the carbon based precursor compound undergoes thermal decomposition to carbon.

A carbon based first coating produced by carbonization can result from pyrolyzing a carbon based precursor compound at temperatures of about 300 to 800° C. in a reaction vessel, for example a crucible. Typically, pyrolyzation of the carbon based precursor compound is conducted at a temperature of at least 200° C. and up to 700° C. for a time period of up to 48 hours, wherein, generally, higher temperatures require shorter processing times to achieve the same effect. In a certain embodiment, carbonization of the carbon based precursor compound is conducted by pyrolyzing the carbon precursor at a temperature of at least 425° C. and up to 600° C. for a time period of up to 48 hours. In different embodiments, the temperature employed in the pyrolysis step is 200° C., 250° C., 300° C., 350° C., 400° C., 450° C., 500° C., 550° C., 600° C., 650° C., or 700° C., or within a temperature range bounded by any two of the foregoing exemplary values. For any of these temperatures, or a range therein, the processing time (i.e., time the carbon based precursor compound is processed at a temperature or within a temperature range) can be, for example, precisely, at least, or no more than 15 minutes, 30 minutes, 1 hour, 2 hours, 3 hours, 4 hours, 5 hours, 6 hours, 12 hours, 18 hours, 24 hours, 30 hours, 36 hours, 42 hours, 48 hours, or within a time range bounded by any two of the foregoing exemplary values. Carbonization to produce first coating 30 may include multiple, repeated steps of pyrolysis with the carbon based precursor compound. Between each step, aggregates can be milled to substantial homogeneity, followed by further pyrolysis with additional carbon based precursor compound. The thickness of the carbon based first coating 30 can be modulated by any number of means, including (i) using repeated pyrolysis steps with carbon based precursor compound, (ii) increasing the amount of carbon based precursor applied to the NanoLi₂S materials, and (iii) the type of carbon based precursor compound. The amount of carbon deposited as first coating 30 may be determined by a measuring a change in weight before and after applying the coating to the NanoLi₂S material.

Typical carbon based precursor compounds that can be used in the carbonization methods disclosed herein, includes carbon based polymers. For example, inexpensive carbon based polymers such as polystyrene (PS), polyacrylonitrile (PAN), and polymetylmetacrylate (PMMA) can be used. Carbon based polymers, unlike explosive gaseous raw carbon sources, are safe to handle and relatively inexpensive.

In a further embodiment, the pyrolysis step described above can be followed by a higher temperature step to further encourage formation of a graphene product. In some embodiments, the additional step is employed primarily to induce further crystallization, particularly when the product resulting from pyrolysis is found to retain an amorphous portion. Typically, the additional step is conducted at a temperature greater than 700° C. and up to 1350° C. for a time of up to 48 hours, wherein, generally, higher temperatures require shorter processing times to achieve the same effect. In different embodiments, the temperature employed in the sintering step is 750° C., 800° C., 850° C., 900° C., 950° C., 1000° C., 1050° C., 1100° C., 1150° C., 1200° C., 1250° C., 1300° C., or 1350° C., or within a temperature range bounded by any two of the foregoing exemplary values. For any of these temperatures, or a range therein, the processing time can be, for example, any of the exemplary processing times or time ranges provided herein.

In alternate embodiment, a first coating 30 is a carbon based coating produced by using a chemical vapor deposition (CVD) process. CVD is a chemical process used to produce high-purity, high-performance solid materials. For the NanoLi₂S composites 120 disclosed herein, a carbon based first coating 30 can be deposited onto a NanoLi₂S core material 10 by placing NanoLi₂S core material 10 under an atmosphere comprising a carbon based precursor compound, such as acetylene, and heating at a temperature so as to pyrolyze the precursor compound. In a particular embodiment, a carbon based first coating 30 can be deposited onto a NanoLi₂S core material 10 by transferring the NanoLi₂S material to a closed furnace tube in a glove box and subsequently in the furnace introducing an inert gas and carbon based precursor compound (e.g., a hydrocarbon) at a defined Standard Cubic Centimeters per Minute (SCCM) flow rate. In a further embodiment, the SCCM flow rate of the inert gas to carbon based precursor compound is introduced at a defined ratio. In a particular embodiment, the inert gas to the carbon based precursor compound is introduced at a SCCM flow rate ratio of 1:10 to 10:1, 1:9 to 9:1, 1:8 to 8:1, 1:7 to 7:1, 1:6 to 6:1, 1:5 to 5:1, 1:4 to 4:1, 1:3 to 3:1, or 1:2 to 2:1. For example, in a particular embodiment, Argon is introduced at 70 SCCM while acetylene is introduced at 10 SCCM resulting in a SCCM flow rate ratio of 7:1. In another embodiment, the CVD process utilizes a carbon based precursor compound selected from methane, ethylene, acetylene, benzene, xylene, carbon monoxide, or combinations thereof. Depending on the particular carbon based precursor compound, the flow rates can be adjusted to desired values using a mass flow controller. The thickness of the carbon coating can be modulated by adjusting the length of time the NanoLi₂S materials are exposed to the carbon based precursor compound, changing the flow rate of the carbon based precursor compound, and/or changing the deposition temperature. In order to achieve a more even carbon coating, the NanoLi₂S materials can be periodically removed from heat and milled to break up any agglomerations. The NanoLi₂S materials are then reheated with the carbon based precursor compound. The amount of carbon deposited can be determined by the change in weight of the NanoLi₂S materials.

To compensate for the poor ionic and electronic conductivity for the sulfur containing electrodes, a liquid electrolyte is conventionally employed, which has a high solubility of lithium polysulfides and sulfide. The utilization of sulfur in batteries containing liquid electrolyte depends on the solubility of these sulfur species in the liquid electrolyte. Further, the sulfur in the positive electrode, e.g., cathode, except at the fully charged state, can dissolve to form a solution of polysulfides in the electrolyte. The concentration of polysulfide species Sₙ²⁻ with n greater than 4 at the positive electrode is generally higher than that at the negative electrode, e.g., anode, and the concentration of Sₙ²⁻ with n smaller than 4 is generally higher at the negative electrode than the positive electrode. The concentration gradients of the polysulfide species drive the intrinsic polysulfide shuttle between the electrodes. The polysulfide shuttle (diffusion) transports sulfur species back and forth between the two electrodes, in which the sulfur species may be migrating within the battery all the time. The polysulfide shuttle leads to poor cyclability, high self discharge, and low charge-discharge efficiency. Further, a portion of the polysulfide is transformed into lithium sulfide (Li₂S), which is deposited on the negative electrode. The “chemical short” leads to the loss of loss of active material from the sulfur electrode, corrosion of the lithium containing negative electrode, i.e., anode, and a low columbic efficiency. Further, the mobile sulfur species causes the redistribution of sulfur in the battery and imposes a poor cycle-life for the battery, in which the poor cycle life directly relates to micro-structural changes of the electrodes. This deposition process occurs in each charge/discharge cycle, and eventually leads to the complete loss of capacity of the sulfur positive electrode. The deposition of lithium sulfide also leads to an increase of internal cell resistance within the battery due to the insulating nature of lithium sulfide. Progressive increases in charging voltage and decreases in discharge voltage are common phenomena in lithium/sulfide (Li/S) batteries, because of the increase of cell resistance in consecutive cycles. Hence, the energy efficiency decreases with the increase of cycle number.

In view thereof, NanoLi₂S based composite 120 can comprise a second coating 60, which prevents the migration of polysulfide species. Second coating 60 may be applied so that the coating uniformly encapsulates first coating 30 or alternatively second coating 60 is applied so that the coating does not uniformly coat first coating 30 (i.e., portions in which the coating is thicker and portions in which the coating is thinner). Alternatively, second coating 60 can be patterned on first coating 30, such as by using lithography based methods.

In order to confine the sulfur more effectively, second coating 60 should be rigid and stable, but not too rigid to break during the expansion of sulfur upon cycling. Moreover, second coating 60 needs to transmit both lithium and electrons. In a particular embodiment, second coating 60 is graphene oxide (GO). In an alternate embodiment, second coating 60 is a conductive polymer selected from polypyrrole (PPy), poly(3,4-ethylenedioxythiophene)-poly(styrene sulfonate) (PEDOT:PSS), polyaniline (PANI), polypyrrole (PPy), polytiophene (PTh), polyethylene glycol, polyaniline polysulfide (SPAn), amylopectin, or combinations thereof.

In a certain embodiment, a GO second coating 60 is applied to carbon coated NanoLi₂S materials by mixing a suspension A and suspension B together, where suspension A comprises GO in N-methyl-2-pyrrolidone (NMP) and suspension B comprises carbon coated NanoLi₂S composite material, Super P carbon black, and polyvinylpyrrolidone binder (PVP) in NMP. In further embodiment, the carbon coated NanoLi₂S/graphene oxide composite material can be isolated from the suspension or used “as is” as a cathode slurry. In another embodiment, the cathode slurry comprises by weight percent between 40 to 95% of NanoLi₂S/graphene oxide composite material.

In an alternate embodiment second coating 60 is a conductive polymer, such as poly(3,4-ethylenedioxythiophene)-poly(styrene sulfonate) (PEDOT:PSS). A conductive polymer second coating 60 can be applied to a composite comprising NanoLi₂S core material 10 and a first coating 30 by applying the polymer to the composite and drying the polymer to remove water. For example, the polymer can be applied to the composite as either a dispersion of gelled particles in water, dispersion of gelled particles in propanediol, or by spin coating the polymer onto the composite. The conductivity of the composite which comprises a second coating 60 of a conductive polymer may be further improved by treating the composite with various compounds, such as ethylene glycol, dimethyl sulfoxide (DMSO), salts, zwitterions, cosolvents, acids (e.g., sulfuric acid), geminal diols, amphiphilic fluoro- compounds, or combinations thereof.

A monolayer of conductive polymer may not be sufficient to fully trap polysulfides. Therefore, NanoLi₂S composite 120 may additionally comprise a conductive polymer-based third coating 90 or even additional coatings in order to further prevent the migration of polysulfide species. Third coating 90 may be used with NanoLi₂S composites with a GO based second coating 60, or with a conductive polymer based second coating 60. Third coating 90 may be applied and post treated in the same manner as second coating 60 that comprises a conductive polymer as described above.

The disclosure further provides that the NanoLi₂S materials disclosed herein or the composites made thereof can be used in a variety of applications, including for use in Li/S batteries. In comparison to conventional Li/S cells the Li/S cells comprising the NanoLi₂S materials have higher energy densities, lower material costs, and better cycling performance. Accordingly, Li/S cells comprising the NanoLi₂S materials could be used in high performance batteries in vehicles, electronic devices, electronic grids and the like. In a particular embodiment, a battery comprises the NanoLi₂S materials disclosed herein or the composites made thereof. In a further embodiment, the battery is a rechargeable Li/S battery. In yet a further embodiment, the battery comprising the NanoLi₂S materials disclosed herein or the composites made thereof is used in consumer electronics, electric vehicles, or aerospace applications.

The following examples are intended to illustrate but not limit the disclosure. While they are typical of those that might be used, other procedures known to those skilled in the art may alternatively be used.

### EXAMPLES

Chemicals and reagents: Sulfur (S), lithium sulfide (Li₂S), 1 M Superhydride (LiEt₃BH) in THF, carbon black (CB), bis(trifluoromethane)sulfonimide lithium salt (LiTFSI, 99.95% trace metals basis), N-methyl-2-pyrrolidone (NMP), 1,3-dioxolane (DOL), and dimethoxyethane (DME) were purchased from Sigma-Aldrich and were used without further purification.

Synthesis of the NanoLi₂S materials. NanoLi₂S materials were prepared by reacting elemental sulfur (S) with 1.0 M lithium triethylborohydride (LiEt₃BH) in tetrahydrofuran (THF), Eq. 2:

S+2Li(CH₂CH₃)₃BH→Li₂S↓+2(CH₂CH₃)₃B+H₂↑ (2)

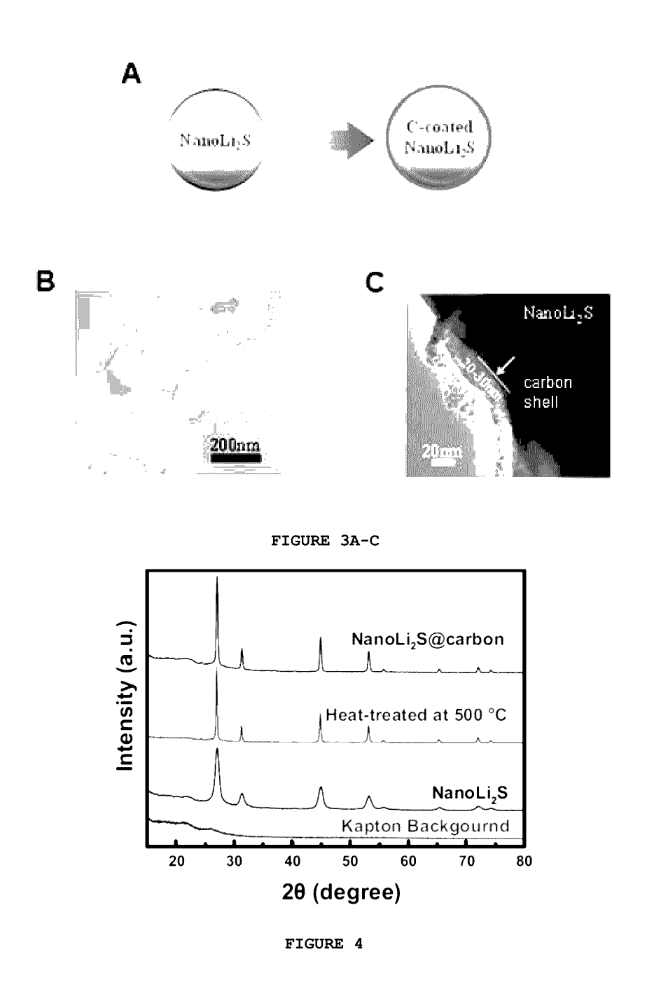

During the reaction, aggregates of Li₂S nanoparticles were precipitated from the THF solution. The particles were generally uniform in size (e.g., see FIG. 2) although some large particle aggregates were also found (e.g., see FIG. 3B). The collected NanoLi₂S particles were washed, centrifuged, and heat-treated at 140° C. in vacuo for 2 hours prior to use.

Carbonization method for applying a carbon coating to the NanoLi₂S materials: A generalized scheme for coating the NanoLi₂S materials is presented in FIG. 3A. Carbon coated NanoLi₂S was prepared by first preparing a 5% solution of PAN in NMP, and then adding NanoLi₂S particles to the solution in a weight ratio of 1 part PAN to 10 parts NanoLi₂S. The suspension was stirred for about 12 hours at ambient temperature. The NMP was then evaporated at 80° C. to leave a dry powder of PAN-coated NanoLi₂S. The carbon coated NanoLi₂S was prepared by the cabonization of PAN-coated NanoLi₂S at 600° C. in flowing Argon. Alternatively, the carbonization step can be performed at a temperature between 425° C. to 600° C. After the carbonization, the carbon layer found on the surface of NanoLi₂S material was found to have a thickness of about 20-30 nm, which correlates to a carbon content of about 5 wt % of the composite (e.g., see FIG. 3C).

Chemical vapor deposition (CVD) method for applying a carbon coating to the NanoLi₂S materials: Carbon coated NanoLi₂S was prepared by transferring NanoLi₂S (50-2000 mg) to a furnace tube and introducing a mixture of Argon gas (70 SCCM) and acetylene (10 SCCM). Alternatively, methane, ethylene, benzene, xylene, and/or carbon monoxide, can be used in place of acetylene, with their flow rates and the furnace temperature adjusted to desired values. Carbon is then deposited on the NanoLi₂S materials by heating at 400° C. or higher. The thickness of the carbon coating can modulated by adjusting the length of time the NanoLi₂S materials are exposed to the carbon containing gas, changing the flow rate of the carbon containing gas, and/or changing the deposition temperature. In order to achieve a more even carbon coating, the NanoLi₂S materials were periodically removed from heat and lightly milled to break up any large agglomerations and then re-heated under the carbon containing gas. The amount of carbon deposited was determined by the change in weight of the materials. Excellent results were obtained by deposition for 30 minutes at 450° C., milling in a glove box, deposition for 60 minutes at 450° C., milling in a glove box, deposition for 120 minutes at 450° C., and milling in a glove box. The carbon coated NanoLi₂S materials were then removed from the furnace tube in a glove box and stored in a sealed container.

Electron imaging of the NanoLi₂S materials and carbon-coated NanoLi₂S composite materials. A TEM image of carbon coated on NanoLi₂S particles is presented in FIG. 3C. A thin layer of carbon is found on the surface of NanoLi₂S, e.g., the thickness of the coating layer is about 20 nm when the carbon content is 5 wt %. This carbon coating allows electron and lithium transports within it. In addition, this carbon coating prevents the NanoLi₂S from directly contacting the liquid electrolyte, which mitigates the polysulfide shuttle, resulting in improved cycling performance.

X-ray diffraction studies on the NanoLi₂S materials and carbon-coated NanoLi₂S composite materials. FIG. 4 shows the X-ray diffraction (XRD) patterns of as-prepared NanoLi₂S, NanoLi₂S after heat-treatment at 500° C., and with 5 wt % carbon coating. The XRD patterns of the NanoLi₂S are identical to those of bulk Li₂S (JCPDS card no. 23-0369). These peaks are identified as a pure phase of Li₂S: 27.2° (111), 31.6° (200), 45.1° (220), 53.5° (311), and 56.0° (222), respectively. The XRD peaks of NanoLi₂S show significant peak broadening compared to those of the bulk Li₂S. The estimated crystallite (or particle) size is 20-30 nm based on the peak broadening of the XRD pattern, which is much smaller than that of bulk Li₂S particles (i.e., the particle size is ˜1 μm). After heat-treatment at 500° C., the peak widths become much narrower, which is due to the crystal growth of NanoLi₂S. The average size of the NanoLi₂S aggregates is 500 nm in diameter post heat-treatment. However, when NanoLi₂S was further coated with carbon by pyrolysis of the PAN polymer on its surface, the average size of the NanoLi₂S aggregates remained unchanged. Therefore, the carbon coating procedure doesn't change the particle size of the NanoLi₂S by heating at 600° C.

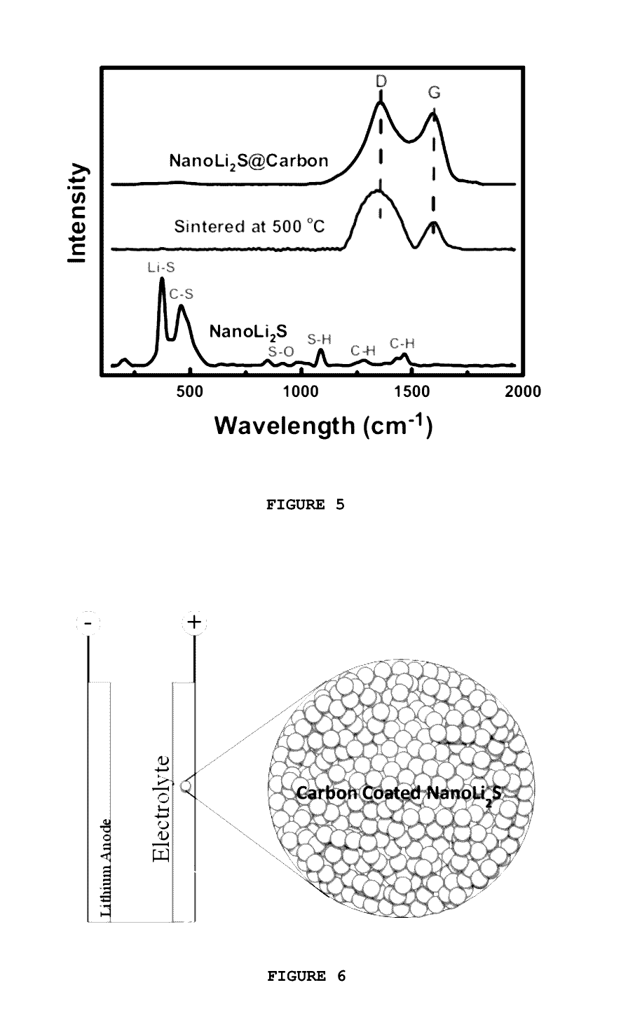

Raman spectra of the NanoLi₂S materials and carbon-coated NanoLi₂S composite materials. Raman spectra of NanoLi₂S, NanoLi₂S after heat-treatment at 500° C. and NanoLi₂S with 5 wt % carbon coating are shown in FIG. 5. Significant peaks are found in the wavenumber range from 250 to 2,000 cm⁻¹ in the Raman Spectra. The strong peak in NanoLi₂S at 375 cm^{31 1} appeared as the evidence of stretching vibrations of the Li—S, and peaks between 700-1500 cm⁻¹ were also detected, which were identified as C—H, C—S, S—H and S—O bonds, and reflect the presence of organic residues. After heat-treatment in Ar at 500° the peak at 1,335 cm⁻¹ is assigned to the disordered graphite structure (D-band), and the peak at 1,587 cm⁻¹ (G-band) corresponds to a splitting of the E2g stretching mode of graphite, which reflects the structural intensity of the sp2-hybridized carbon atoms. The G- and D-bands in the Raman spectrum suggest the typical amorphous carbon coating on the surface of NanoLi₂S. The relative intensity of the NanoLi₂S peak indicates the thickness of the carbon coating. After heat-treatment at 500° C. and carbon coating, the diffraction peaks of NanoLi₂S disappear, due to a thin layer of carbon forming on the NanoLi₂S materials. The diffraction peaks of both XRD and Raman spectra confirm that the NanoLi₂S materials are coated with carbon so as to form a composite material.

Method to produce carbon coated NanoLi₂S/graphene oxide composite materials: Electrodes were prepared from the above carbon-coated NanoLi₂S as follows. The cathode slurry was prepared by mixing carbon coated NanoLi₂S with very small flakes of graphene oxide (GO) by dispersing GO (7.5 mg) in NMP (0.5 mL) and agitating the suspension for about 0.5 hr in a sonicating bath. In parallel, a suspension of carbon coated NanoLi₂S (30 mg), Super P carbon black (10 mg), and polyvinylpyrrolidone (PVP) binder (2.5 mg) in NMP (1 mL) was prepared and sonicated for about 0.5 hr. The above two suspension were then mixed and sonicated for 15-20 minutes. The composition of the cathode slurry contained: 75 wt % of the carbon-coated Li₂S-GO composite (80% Li₂S and 20% GO), carbon black (20 wt %), and PVP binder (5 wt %) in NMP as the suspending liquid.

Alternative method to produce carbon coated NanoLi₂S/graphene oxide composite materials: The carbon coated NanoLi₂S was also prepared by the carbonization of a mixture of polyacrylonitrile (PAN) and NanoLi₂S at 500° C. in Ar. PAN was used as carbon precursor. GO was dispersed in NMP using sonication, and then carbon-coated-nanoLi₂S was added and sonicated for 0.5 hr. After that, carbon black and PVP were added to prepare the cathode slurry. The composition of the cathode slurry contained: carbon-coated-NanoLi₂S/GO composite (65 wt %), carbon black (30 wt %), and PVP binder (5 wt %) in NMP as the suspending liquid.

Production of electrodes comprising the carbon coated NanoLi₂S/Graphene oxide composite materials: The cathode slurry from above was coated onto carbon paper (the current collector) which was assembled with the lithium metal foil into a traditional coin cell by depositing the suspension dropwise onto the carbon paper (˜240 micrometers thick). The coated paper was then assembled with a lithium metal foil negative electrode into a traditional coin cell (Type 2032). The cell was assembled using the traditional configuration, i.e., carbon coated NanoLi₂S with GO as the cathode, 0.18 M LiNO₃+1 M LiTFSI in PYR₁₄TFSI/DME/DOL (2:1:1 by volume) as the liquid electrolyte, and metallic lithium as the anode, respectively. The electrode loading was 2.3 mg of mixture/cm², or 1.5 mg Li₂S/cm².

Electrochemical evaluation and structure characterization of the NanoLi₂S materials. Coin cells were used to evaluate the cycling performance. Low surface area carbon black (surface area ˜50 m²/g) coated aluminum foil or carbon paper was used as the current collector. Charge and discharge were carried out using a Maccor 4000 series cell tester at a current density of 0.2 mA cm² (C/10) between the cut-off potentials of 1.5-2.8 V vs. Li/Li⁺. The current densities of 0.4 (C/5) and 0.75 (C/2.7) mA cm⁻² were applied to measure the rate capability. The calculation of specific charge/discharge capacities is based on the mass of lithium sulfide and sulfur content. The structures of the sulfur electrode before and after cycling were examined using a field emission STEM (Hitachi HF-3300) at 15 kV. The elemental mapping of the samples was also taken using STEM. X-ray diffraction (XRD) analysis was performed at a PANalytical X′pert PRO2-circle X-ray diffractometer with a CuKα radiation (λ≈1.5418 Å). Raman spectroscopy was recorded from 500 to 200 cm⁻¹ on a Renishaw Confocal MicroRaman spectrometer at room temperature.

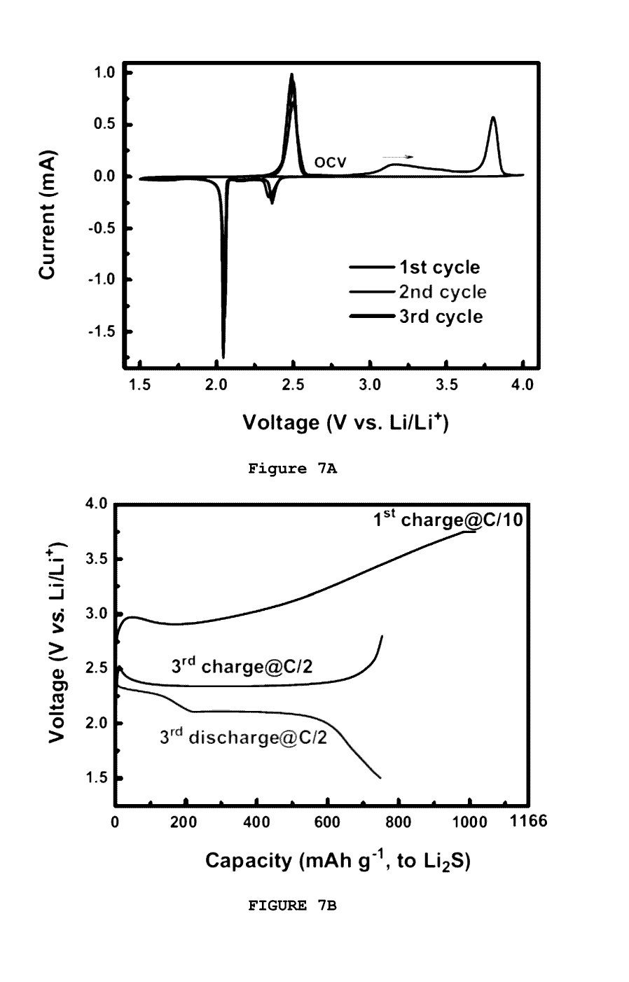

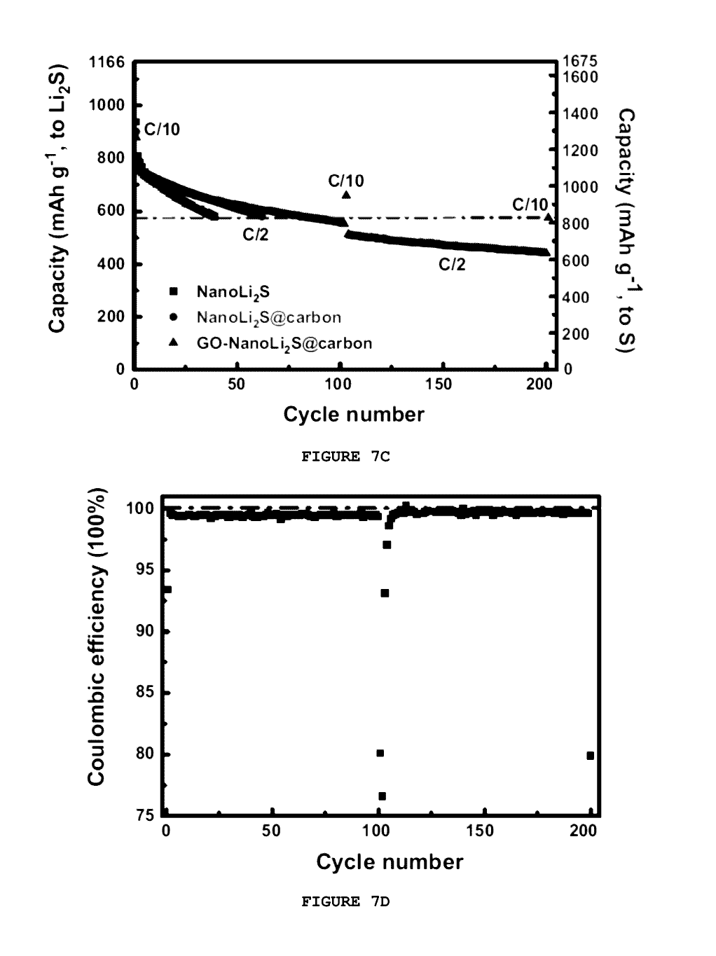

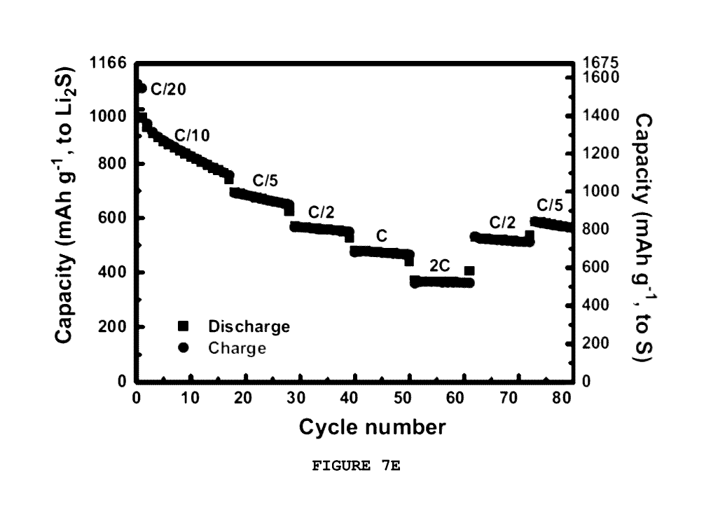

Electrochemical performance of NanoLi₂S materials. A schematic of carbon coated NanoLi₂S as cathode material for Li/S cells is presented in FIG. 6. To determine the electrochemical behavior and reversibility, cyclic voltammograms (CV) of the Li/S cell were obtained by using carbon-coated NanoLi₂S/GO composite materials as the cathode in the liquid electrolyte (e.g., see FIG. 7A). When scanning upward in potential from the open circuit voltage (OCV) at the 1^{st} cycle, two broad oxidation peaks between 3.0-4.0 V were caused by two lithium extractions from NanoLi₂S. In a conventional Li/S cell, the oxidation potential to sulfur species is always around 2.5 V. The higher oxidation potentials presented herein are caused by the low conductivities and poor lithium extraction kinetics of NanoLi₂S during the electrochemical reaction. When scanning to low potentials, two clear reduction peaks around 2.0 and 2.4 V are found: the one around the 2.4 V is comprised of the transformation of S to higher-order Li₂Sₓ (4≦x≦8), and the other peak at around 2.0 V was caused by a further reduction of the higher-order lithium polysulfides to lower-order Li₂Sₓ (x≦4), and finally to Li₂S. After scanning upward to 2.8 V, one clear oxidation peal was found, which confirms the good reversibility of sulfur species such as Li₂Sₓ (x=1 or 2). The same situations were also found at the 2^{nd} and 3^{rd} cycle; therefore, the potential range of 1.5-2.8 V vs. Li/Li⁺ was chosen for further evaluation of the cycling performance. FIG. 7B shows the typical charge-discharge profiles of cathodes comprising the carbon-coated NanoLi₂S/GO composite material when using the cut-off potentials of 1.5-3.75 V for the 1st charge at C/10, and 1.5-2.8 V in the following cycles at C/2 (1C=1,166 mA g⁻¹ Li₂S). At the 1^{st} charge, the voltage keeps increasing until the cut-off voltage of 3.75 V is reached, which confirms the continuous lithium extraction from NanoLi₂S. For the charge-discharge curves of the Li/S cell at the 3^{rd} cycle, two voltage plateaus at 2.4 and 2.0 V during the discharge procedure, which correspond to the reduction of long chain polysulfides (Sₓ²⁻, 4≦x) and short chain polysulfides (Sₓ²⁻, x≦4), are found. The ratio of the first plateau at 2.4 V to the second plateau at 2.0 V is about 1:3, which indicates the possible blockage of the polysulfide shuttle. The plateau at high voltage (2.4 V) is also found during charging process; all of these results are consistent with those of the CV profiles.

Excellent cycling performance was demonstrated when using the carbon-coated NanoLi₂S/GO composite materials as the cathode material for Li/S cells (e.g., see FIG. 7C). Cathodes comprising carbon-coated NanoLi₂S/GO composite material had an initial discharge specific capacity of 902 mAh g⁻¹ at C/10 (Unless otherwise noted, the capacities hereafter are normalized to the weight of Li₂S; however, the capacities are also shown in terms of the weight of sulfur for reference), which is 77.4% of its theoretical specific capacity. At the 2^{nd} cycle at C/2, the carbon-coated NanoLi₂S/GO composite material had a capacity of 761 mAh g⁻¹. After 60 cycles, the capacity decayed to 582 mAh g⁻¹, which is about ½ of its theoretical maximum. Though the initial discharge capacity of the NanoLi₂S material is much higher than that of the carbon-coated NanoLi₂S composite material at C/2 (810 vs. 761 mAh g-1), it quickly decays to 582 mAh g⁻¹ only after 37 cycles. The cycling performance of the NanoLi₂S material was improved by forming a carbon-coating on the NanoLi₂S material, which not only enhances the conductivity of the composite material but also prevent the particles from directly contacting the organic electrolyte. As a result, the polysulfide shuttle is greatly inhibited.

The cycling performance of the carbon-coated NanoLi₂S composite materials was further improved by mixing with GO (20 wt %). The initial discharge capacity of carbon-coated NanoLi₂S/GO composite material was 757 mAh g⁻¹ at C/2. After 200 cycles, the capacity decayed to 441 mAh g⁻¹, which demonstrates a capacity retention rate of 58.3%. When the carbon-coated NanoLi₂S/GO composite material was cycled at the low rate of C/10, the capacity recovered to about ½ of its theoretical maximum, i.e., 575 mAh g⁻¹. The further improvement in the cycling performance is likely due to the GO functional groups, which can chemically immobilize the polysulfides in the cathode during cycling. These results were further confirmed by the fact that this material has a high coulombic efficiency (e.g., see FIG. 7D). The coulombic efficiency of the carbon-coated NanoLi₂S/GO composite materials was initially about 93%, which subsequently increased to ˜100% for the subsequent cycling. However, it should be noted that the coulombic efficiency did decrease to ˜75% after 100 cycles at the low rate of C/10. Though the capacity is much higher when the rate of C/10 was chosen, the polysulfide shuttle is more severe at low cycling rates than at high rates. But, after a few cycles at C/2, the coulombic efficiency recovered to 100%. Such a high coulombic efficiency indicates the mitigation of the polysulfide shuttle, which has been proven to be the main cause of low coulombic efficiency in the traditional Li/S cells when using organic liquid electrolytes. When using the carbon-coated-NanoLi₂S/GO composite material as the cathode material for Li/S cells at high current densities, excellent rate capability is achieved (e.g., see FIG. 7E). The cell shows a reversible capacity of 360 mAh g⁻¹ Li₂S at the 2C rate after 50 cycles at various rates, and further cycling at a low rate of C/10 brings it back to a reversible capacity of 587 mAh g⁻¹. FIG. 7E demonstrates the benefits of carbon coating for improving conductivity, and GO for chemically constraining the polysufides within the cathode.

Soluble polysufides cause the migration of sulfur species from the sulfur cathode to the Li anode, where they electrochemically react with metallic Li, resulting in active material loss and low coulombic efficiency (e.g., <90%). Considering the good cycling performance (65.4% capacity retention after 200 cycles) and high coulombic efficiency (˜100%) when using carbon-coated-NanoLi₂S/GO composite materials as cathode materials, the success of the carbon coating and GO in protecting against sulfur loss was shown.

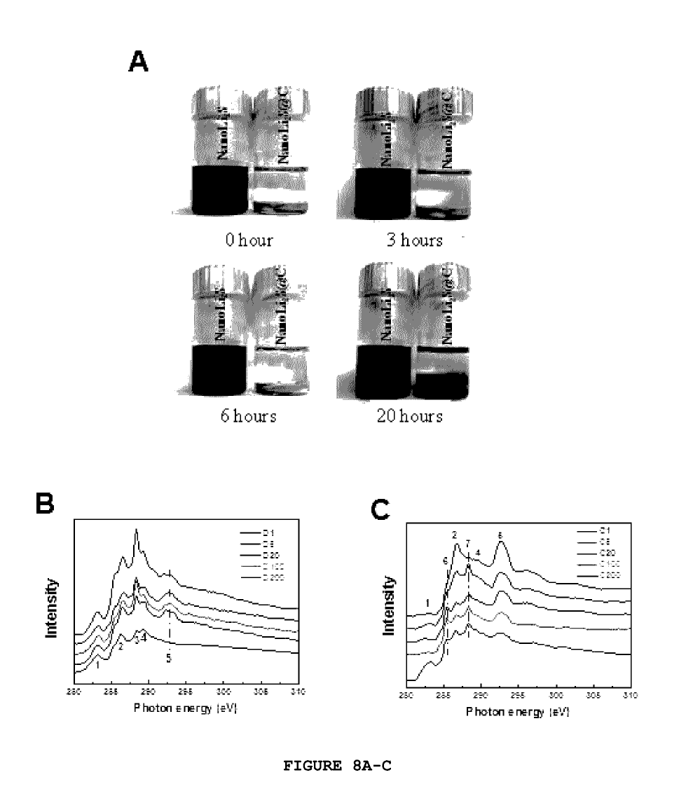

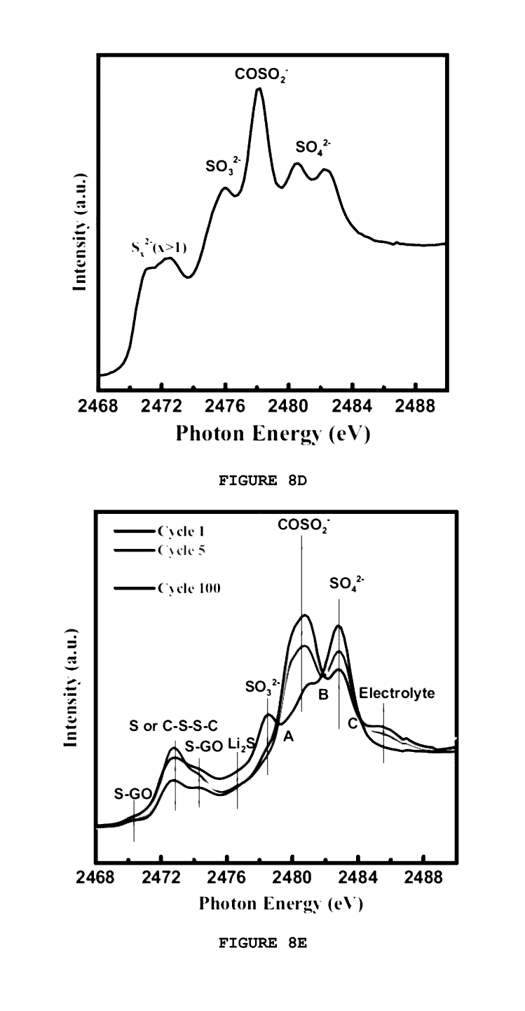

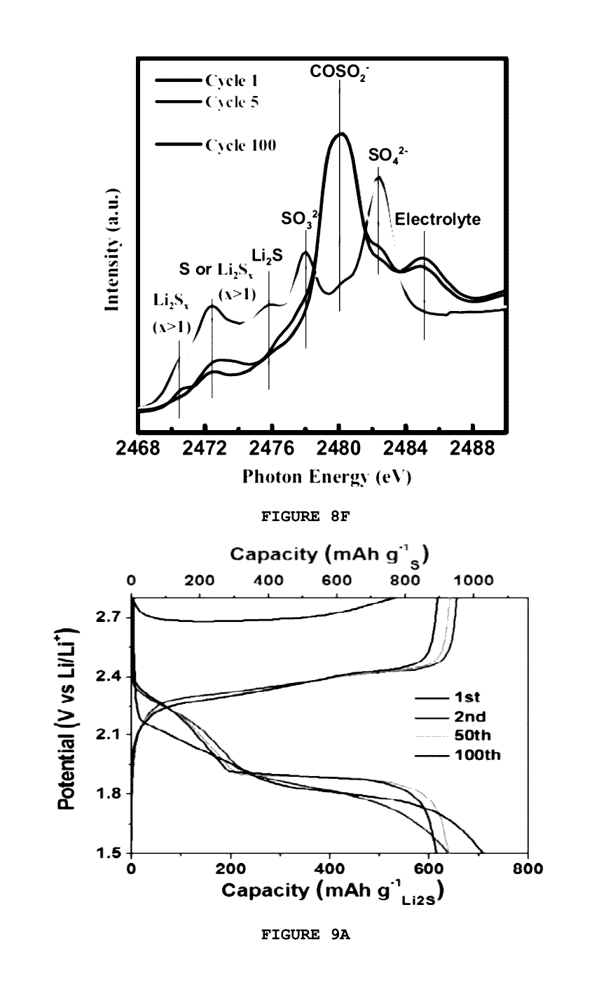

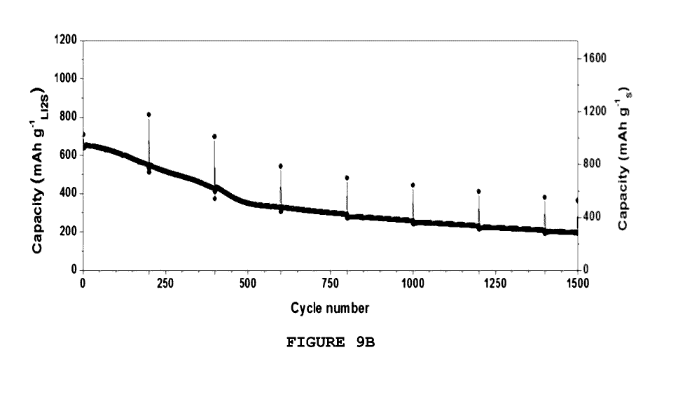

A bench-top test of polysulfide dissolution and sulfur species composition was used to probe the methods for sulfur protection. The polysulfide dissolution test using NanoLi₂S material and carbon-coated-NanoLi₂S composite material is shown in FIG. 8A. When adding NanoLi₂S material to the electrolyte solution of 0.18 M LiNO₃+1 M LiTFSI in PYR₁₄TFSI/DME/DOL (2:1:1 by volume), the color of the solution immediately became dark-brown, indicating the formation of Li₂S₈. By comparison, there was no color change when adding the carbon-coated-NanoLi₂S composite material to the test solution. Further, the color remained nearly unchanged after standing for 6 hours, indicating that the NanoLi₂S material was protected from the test solution by the carbon coating. There was a color change after overnight (20 hours), thereby indicating the gradual formation of polysulfides. In addition, GO was chosen to further constrain polysulfides in the cathode during cycling.

NEXAFS spectra were used to study the interaction among the materials in the sulfur electrodes (e.g., see FIGS. 8B and 8C). The C K-edge spectra shown in FIGS. 8B and 8C reveal remarkable changes in the chemical structure of the electrode materials after cycling. As can be seen in the electrodes fully discharged to Li₂S (FIG. 8B), four distinct features located at 283.3, 286.3, 288.4, and 289.2 eV were observed before cycling. By comparing the results with studies on pure GO, Li₂S@C nanocomposites and other carbon related materials, the strong peaks of 283.3 and 286.3 eV were assigned to the C 1s transition to n* of GO and/or carbon black, the 288.4 eV peak was attributed to the transition from C is to C—H and C—S σ*, and the 289.2 eV peak was assigned to the transition of C is level to the σ* of —CH₂— species. After cycling, significant changes in the C K-edge spectra were observed with increasing numbers of cycles: (1) the damping of the peak at 286.3 eV; (2) the intensity decrease of the 288.4 eV feature; (3) the development of one new feature located at 292.6 eV. The peak around 292.6 eV corresponds to transitions from the is level to dispersionless σ* states at the Γ point of the graphene Brillouin zone (BZ). The above results indicate that bonds have formed between the functional groups on GO and polysulfide and/or NanoLi₂S material. These results were consistent with those for the fully charged electrodes (converted to S) (e.g., see FIG. 8C). Except for the peaks numbered 1, 2, 4, and 5, two new peaks at 285.7 and 288.3 eV, originating from the C—S σ* excitations, are observed for the charged electrodes. The peaks 2 and 5 originating from a different functional group (possibly the C—O bond) on the GO are weakened significantly during cycling, indicating a strong chemical interaction between S and the functional group. The results presented herein confirm the strong interaction between the functional groups on GO and sulfur species during charge-discharge.

GO was further chosen to constrain the polysulfides in the cathode during cycling; and the sulfur anchoring is illustrated in FIG. 8D by using NEXAFS spectroscopy in the TFY mode. There are six peaks found in the NEXAFS spectra of the NanoLi2S/GO composite. The peaks at 2470.80 and 2472.37 eV were attributed to the transition of S 1s to πn state of linear polysulfides and the transition from the S is core level to the S—S π* state of linear polysulfides (Sₓ²⁻ X>1); the peaks located at 2476.17, 2478.12, 2480.32, and 2482.42 eV are assigned to the σ* state of Li2S, the S²⁻ σ* state and/or the SO₃²⁻ σ* state, the COSO₂⁻ σ* state, and the SO₄²⁻ σ* state, respectively. Comparing with the peaks of NanoLi2S only, there should be two peaks observed at 2472-2473 eV; however, the peak at 2473.32 eV may overlap with the broad peak located at 2472.37 eV. Most of the Li₂S was bonding with oxygen functional groups of the GO sheet by forming S—O, and part of the Li2S was transformed to Li₂Sₓ (x>1). The above evidence shows the strong chemical bonding between the NanoLi₂S and GO, which can chemically immobilize sulfur species in the cathode.

In order to study the capacity loss mechanism during cycling, NEXAFS spectra were used to characterize the GO-NanoLi₂S@carbon composites at the end of charge/discharge after different numbers of cycles. Since NanoLi₂S was used as the S cathode material, the cell was first charged. FIG. 8E shows the total-fluorescence-yield (TFY) S K edge NEXAFS spectra of the cathode material after five different numbers of charge/discharge cycles and stopped in the charged state. After the first charge, several significant changes were observed, which reflect the evolution of the S chemical species: the disappearance of the peak at 2470.80 eV, the decay of the peak at 2476.00 eV, the appearance of peaks at 2470.34 and 2473.89 eV, and the intensification of the SO₄²⁻ peak. The peaks at 2472.37 and 2473.89 eV are originated from the S—S bonding and the C—S bonding, respectively. The small peak at 2470.34 eV is associated with the bonding of S to GO, but the specific transition involved is still an open question. These S species are active species that are involved in the charge/discharge process. According to the Li₂S. (x>1) and Li₂S peak intensity evolution located at 2470.80 and 2476.00 eV, the Li₂Sx (x41) species were fully oxidized to elemental S8 while the Li₂S was partly oxidized during the first charge. In the meantime the S species were bonded to the GO sheets and formed C-S bonds, which help to immobilize sulfur in the cathode.

With the increasing numbers of charge/discharge cycles, several significant peak intensities evolve. First, the peak intensity originating from the S8 and/or C—S—S—C became stronger after 5 cycles, due to the conversion of more Li₂S to active S species during the first few cycles. With increasing cycle numbers, the active S peak intensity decreased, which might be caused by polysulfide dissolution. Second, the peak intensities of SO₃²⁻ and SO₄²⁻ continuously decay, while the peak intensity of the COSO₂⁻ specie is always increasing. The interesting point is that all the spectra go through three points marked as A, B and C in the figure, which are attributed to phase transition phenomena. The SO₃²⁻ and SO₄²⁻ were most likely to convert to the COSO₂⁻ specie within the cycling process, which are all unexpected products during cycling. Finally, there is a peak located even higher than where SO₄²⁻ is, which is assigned to the remaining electrolyte. The intensity of this peak increases with the increasing cycle number as this specie comes from the electrolyte and stays on the cathode surface, which is also confirmed by total-electron-yield (TEY) spectra. As the TEY mode is more surface-sensitive than the TFY mode, these species are more likely to accumulate on the cathode surface and form a new layer at the cathode/electrolyte interface. This layer hinders the diffusion of Li-ions within the cathode, leading to the lower utilization of active sulfur species and subsequent capacity fading during cycling.

TFY S K-edge NEXAFS of cathode materials recorded after different numbers of cycles and stopped in the discharged state are shown in FIG. 8F. After the first discharge, the peak intensity of lithium polysulfides increases while the intensity of the Li₂S peak decreases. This indicates that the elemental S8 was mostly reduced to Li₂S. (x>1) during discharge. As a result, the proposed electrochemical reaction of 2Li+xS⇄Li₂Sₓ, (1≦x>8) is demonstrated. Comparing with the fresh cathode material, the ratio of the peak at 2470.80 eV to the peak at 2472.34 eV is much smaller at the discharged state.

In summary, high-performance Li/S cells were developed by using carbon-coated NanoLi₂S/GO composite material as the cathode material, which consisted of GO mixed with a carbon-coated NanoLi₂S material. This carbon coating significantly reduced the contact of NanoLi₂S with the liquid electrolyte, thereby greatly improving the cycling performance of Li/S cells. The cells using the carbon coating show better cyclability than those using uncoated NanoLi₂S. The cycling performance of Li/S cells using carbon-coated NanoLi₂S material was further improved by mixing with GO. The functional groups on the surface of GO chemically interact with the polysulfides, which helped prevent the polysulfides from dissolving in the electrolyte and thereby reacting with the lithium anode. As a result, the polysulfide shuttle is greatly mitigated. In particular, the resulting Li/S cell demonstrated an initial specific discharge capacity of 879 mAh g⁻¹ (1,263 mAh g⁻¹ when normalized to sulfur) at the rate of C/10 and capacity retention of 65.4% after 200 cycles. The disclosure therefore provides a new approach for designing novel Li₂S cathodes for Li/S cells that have excellent cycling performance and sulfur utilization.

A number of embodiments have been described herein. Nevertheless, it will be understood that various modifications may be made without departing from the spirit and scope of this disclosure. Accordingly, other embodiments are within the scope of the following claims.

1. A method of synthesizing a nano-lithium-sulfide (NanoLi₂S) material comprising
reacting elemental sulfur with a lithium-based reducing agent in an aprotic solvent; and
coating the NanoLi₂S material with a conductive carbon based coating comprising:
applying a coating of a carbon based polymer to the NanoLi₂S material;
pyrolyzing the polymer coated nanoLi₂S material under an inert atmosphere so as to form a pyrolitic carbon based coating on the NanoLi₂S materials.

2. The method of claim 1, wherein the aprotic solvent is tetrahydrofuran.

3. The method of claim 1, wherein the lithium-based reducing agent is selected from lithium triethylborohydride, n-butyllithium, and lithium aluminum hydride.

4. The method of claim 1, wherein the NanoLi₂S material primary particle size is between 20 to 30 nm in size.

5. The method of claim 1, wherein the solvent is removed in vacuo and the NanoLi₂S material is heated at an elevated temperature.

6. The method of claim 5, wherein the NanoLi₂S material is heat treated at a temperature of at least 500° C.

7. The method of claim 6, wherein the NanoLi₂S material is uniformly sized particles having a diameter between 200 to 700 nm.

8. The method of claim 1, wherein the NanoLi₂S material is substantially spherical or substantially ovoid in shape.

9. (canceled)

10. The method of claim 1, wherein the carbon based polymer is selected from polystyrene (PS), polyacrylonitrile (PAN), polymetylmetacrylate (PMMA), or combinations thereof.

11. The method of claim 10, wherein the polymer coated nanoLi₂S material is pyrolyzed by heating the material at a temperature between 400° C. to 700° C. for up to 48 hours.

12. The method of claim 11, further comprising heating the carbon coated NanoLi₂S materials at a temperature greater than 700° C. to 1350° C. for up to 48 hours so as to form a pyrolytic graphene based coating on the NanoLi₂S materials.

13. The method of claim 1, wherein the steps are repeated multiple times where the carbon coated NanoLi₂S materials are milled after each pyrolyzation step to break up any large agglomerations.

14. A method comprising:
reacting elemental sulfur with a lithium-based reducing agent in an aprotic solvent to obtain NanoLi₂S material;
placing the NanoLi₂S material under an atmosphere which comprises inert gas and carbon containing precursor compound, wherein the inert gas and carbon containing precursor compound are independently introduced at defined Standard Cubic Centimeters per Minute (SCCM) flow rates; and
depositing a carbon coating on the NanoLi₂S material by pyrolyzing the carbon containing precursor compound at a temperature between 400° C. to 700° C. for up to 48 hours.

15. The method of claim 14, wherein the steps are repeated multiple times where the carbon coated NanoLi₂S materials are milled after each deposition step to break up any large agglomerations.

16. The method of claim 15, wherein the method comprises three deposition steps of 30 minutes, 60 minutes, and 120 minutes at 450° C., and where the carbon coated NanoLi₂S materials are milled after each depositing step.

17. The method of claim 14, wherein the carbon containing precursor compound is selected from methane, ethylene, acetylene, benzene, ethane, carbon monoxide, or combinations thereof.

18. The method of claim 14, wherein the SCCM flow rate of the inert gas and carbon containing precursor compound is adjusted to desired flow rates using a mass flow controller.

19. The method of claim 14, wherein the SCCM flow rate ratio of inert gas to carbon containing precursor compound is from 10:1 to 1:10.

20. A method of claim 14 further comprising coating the carbon coated NanoLi₂S material with a coating to prohibit the migration of polysulfide species, comprising:
applying a coating of graphene oxide (GO) or a conductive polymer to the carbon coated NanoLi₂S material.

21. The method of claim 20, wherein a coating of GO is applied to the carbon coated NanoLi₂S material by:
combining suspension A comprising GO in NMP with suspension B comprising carbon coated NanoLi₂S, Super P carbon black, and polyvinylpyrrolidone (PVP) binder in NMP.

22. The method of claim 21, wherein the suspensions are agitated using sonification.

23. The method of claim 22, wherein the combined suspensions form a composition where the carbon coated NanoLi₂S/GO composite makes up 50% to 85% by weight of the composition, not including the liquid solvent.

24. The method of claim 20, wherein the conductive polymer is selected from polypyrrole (PPy), poly(3,4-ethylenedioxythiophene)-poly(styrene sulfonate) (PEDOT:PSS), polyaniline (PANI), polypyrrole (PPy), polytiophene (PTh), polyethylene glycol, polyaniline polysulfide (SPAn), amylopectin, or combinations thereof.

25. The method of claim 24, wherein the carbon coated NanoLi₂S material composite comprising a conductive polymer coating is treated with ethylene glycol, dimethyl sulfoxide (DMSO), salts, zwitterions, cosolvents, acids (e.g., sulfuric acid), geminal diols, amphiphilic fluoro- compounds, or combinations thereof.

26. The method of claim 25 further comprising coating the composite material with one or more coatings of conductive polymer, comprising:
applying one or more coatings of a conductive polymer to the carbon coated NanoLi₂S GO composite material or the carbon coated NanoLi₂S conductive polymer composite material.

27. The method of claim 26, wherein the conductive polymer is selected from polypyrrole (PPy), poly(3,4-ethylenedioxythiophene)-poly(styrene sulfonate) (PEDOT:PSS), polyaniline (PANI), polypyrrole (PPy), polytiophene (PTh), polyethylene glycol, polyaniline polysulfide (SPAn), amylopectin, or combinations thereof.

28. The method of claim 27, wherein the composite material is treated with ethylene glycol, dimethyl sulfoxide (DMSO), salts, zwitterions, cosolvents, acids (e.g., sulfuric acid), geminal diols, amphiphilic fluoro-compounds, or combinations thereof.

29. A carbon-coated nano-lithium sulfur particles produced by the method of claim 14.

30. A battery comprising a NanoLi₂S based material of claim 29.

31. The battery of claim 30, wherein the battery is a lithium sulfide battery.

32. The battery of claim 30, configured to be used in electronic devices or electric vehicles.
